(19) United States
(12) Patent Application Publication
(10) Pub. No.: US 2014/0352611 A1
(43) Pub. Date: Dec. 4, 2014

(54) COATING APPARATUS AND METHOD OF CLEANING SEALING UNIT

(71) Applicant: Tokyo Electron Limited, Tokyo (JP)

(72) Inventors: Tetsuya MAKI, Koshi City (JP); Hayato TANOUE, Kikuchi-gun (JP)

(73) Assignee: TOKYO ELECTRON LIMITED, Tokyo (JP)

(21) Appl. No.: 14/287,593

(22) Filed: May 27, 2014

(30) Foreign Application Priority Data
May 29, 2013 (JP) 2013-113277
Apr. 3, 2014 (JP) 2014-077052

(51) Int. Cl. B05B 15/02

(52) U.S. Cl. CPC B05B 15/025
USPC 118/302; 134/42

(57) ABSTRACT

Provided is a coating apparatus which includes: a slit nozzle provided with a discharge port at a lower side of the slit nozzle, and configured to discharge a coating liquid from the discharge port; a moving mechanism configured to move the slit nozzle relative to a substrate; a sealing unit formed to extend along a longitudinal direction of the discharge port, and including a top surface which is brought into contact with the discharge port to seal the discharge port; a solvent reservoir configured to retain a solvent; and an immersing mechanism configured to immerse the sealing unit into the solvent retained in the solvent reservoir.

### CROSS-REFERENCE TO RELATED APPLICATIONS

This application claims the benefit of Japanese Patent Application Nos. 2013-113277, filed on May 29, 2013; and 2014-077052, filed on Apr. 3, 2014 in the Japan Patent Office, the disclosure of which is incorporated herein in their entirety by reference.

### TECHNICAL FIELD

The present disclosure relates to a coating apparatus and a method of cleaning a sealing unit.

### BACKGROUND

In the related art, a spin coating method is known as a method of forming a coating film on a substrate such as a semiconductor wafer or a glass substrate. The spin coating method widely spreads a coating liquid dropped on a substrate over the entire surface of the substrate by virtue of a centrifugal force, thereby forming the coating film. However, most of the coating liquid dropped on the substrate scatters and falls off of the substrate.

To address the above concern, a slit coating method is proposed as an alternative method for the spin coating method. The slit coating method scans an elongated slit nozzle having a slit-like discharge port on a substrate, thereby forming a coating film on the substrate.

In the slit coating method, the slit nozzle is merely scanned once from one end of the substrate to the other end thereof, thus forming the coating film on the substrate without dropping a coating liquid on the substrate. As such, the slit coating method has an enhanced usability of the coating liquid as compared with the spin coating method.

There is available a technology in which, when a coating liquid is supplied into a slit nozzle, a sealing unit is brought into contact with a discharge port of the slit nozzle such that the discharge port is sealed by the sealing unit.

However, such a technology causes the coating liquid to accumulate in the sealing unit for every sealing operation. The accumulated coating liquid is dried into particles, which contaminates peripheral devices or the like. As such, the coating liquid adhering to the sealing unit needs to be removed.

### SUMMARY

Some embodiments of the present disclosure provide a coating apparatus and a method of cleaning a sealing unit, which are capable of properly removing a coating liquid adhering to a sealing unit that seals a discharge port of a slit nozzle.

According to one embodiment of the present disclosure, provided is a coating apparatus which includes: a slit nozzle provided with a discharge port at a lower side of the slit nozzle, and configured to discharge a coating liquid from the discharge port; a moving mechanism configured to move the slit nozzle relative to a substrate; a sealing unit formed to extend along a longitudinal direction of the discharge port, and including a top surface which is brought into contact with the discharge port to seal the discharge port; a solvent reservoir configured to retain a solvent; and an immersing mechanism configured to immerse the sealing unit into the solvent retained in the solvent reservoir

According to another embodiment of the present disclosure, provided is a method of cleaning a sealing unit, for use in a coating apparatus which includes: a slit nozzle provided with a discharge port at a lower side thereof and configured to discharge a coating liquid from the discharge port; a sealing unit formed to extend along a longitudinal direction of the discharge port and including a top surface which is brought into contact with the discharge port to seal the discharge port; and a solvent reservoir configured to retain a solvent. The method includes: exposing at least a portion of the sealing unit making contact with the discharge port from the solvent retained in the solvent reservoir; bring the discharge port into contact with the top surface of the sealing unit such that the discharge port is sealed by the sealing unit; and immersing the top surface of the sealing unit into the solvent retained in the solvent reservoir.

### BRIEF DESCRIPTION OF THE DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIG. 1 is a schematic view showing a configuration of a coating apparatus according to a first embodiment.

FIG. 2 is a schematic view showing a coating process.

FIG. 3 is a schematic view showing a configuration of a nozzle waiting section according to the first embodiment.

FIG. 4 is a schematic view of a solvent reservoir.

FIG. 5 is a schematic view of a sealing unit.

FIG. 6 is a view showing a sealing operation performed by the sealing unit.

FIG. 7 is a schematic view showing a configuration of a slit nozzle and configurations of units connected to the slit nozzle.

FIGS. 8A and 8B are views showing an operation of cleaning a sealing unit.

FIG. 9A is a view showing a coating liquid adhering to a sealing unit.

FIG. 9B is a view showing an operation of a scraping unit.

FIG. 10 is a schematic view showing a configuration of a priming mechanism.

FIG. 11 is a schematic view showing a configuration of a priming unit provided in the priming mechanism.

FIG. 12 is a view showing a sealing operation performed by a sealing unit according to a second embodiment.

FIG. 13A is a view showing an example of a cleaning operation of the sealing unit according to the second embodiment.

FIG. 13B is a view showing another example of a cleaning operation of the sealing unit according to the second embodiment.

FIGS. 14A to 14D are views showing examples of various shapes of a sealing unit.

### DETAILED DESCRIPTION

Reference will now be made in detail to various embodiments of a coating apparatus and a method of cleaning a sealing unit, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

### First Embodiment

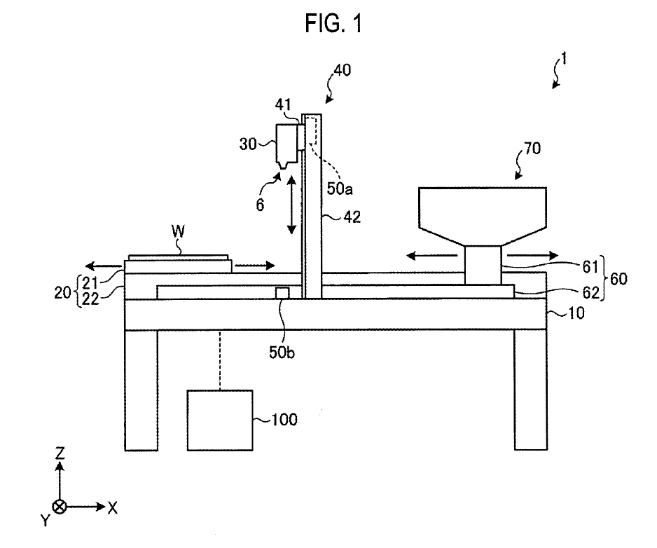

FIG. 1 is a schematic view showing a configuration of a coating apparatus according to a first embodiment. For the clarification of a positional relationship, an X-axis direction, a Y-axis direction and a Z-axis direction, which are orthogonal to one another, are defined in the following description and a positive Z-axis direction is defined as a vertical upward direction.

As shown in FIG. 1, a coating apparatus 1 according to the first embodiment includes a mounting table 10, a first moving mechanism 20, a slit nozzle 30 and a lift mechanism 40.

The first moving mechanism 20 is configured to move a substrate W in a horizontal direction. The first moving mechanism 20 includes a substrate holding unit 21 and a driving unit 22.

The substrate holding unit 21 includes a horizontal upper surface having suction holes formed therein. The substrate W is held on the horizontal upper surface by virtue of a suction force through the suction holes. The driving unit 22 is mounted on the mounting table 10 and is configured to move the substrate holding unit 21 in the horizontal direction (the X-axis direction in FIG. 1).

The first moving mechanism 20 moves the substrate holding unit 21 through the use of the driving unit 22, thereby moving the substrate W held on the substrate holding unit 21 in the horizontal direction (the X-axis direction in FIG. 1).

The slit nozzle 30 has an elongated shape extending in a direction (i.e., the Y-axis direction) orthogonal to the horizontal direction (i.e., the X-axis direction) in which the substrate W is moved. The slit nozzle 30 discharges a high-viscosity coating liquid such as a resist or an under-fill material from a slit-like discharge port 6 formed at a lower side thereof. The detailed configuration of the slit nozzle 30 will be described later.

The lift mechanism 40 is configured to lift and lower the slit nozzle 30. The lift mechanism 40 includes a fixing unit 41 configured to fix the slit nozzle 30, and a driving unit 42 configured to move the fixing unit 41 in the vertical direction.

The lift mechanism 40 moves the fixing unit 41 in the vertical direction through the use of the driving unit 42, thereby lifting and lowering the slit nozzle 30 fixed to the fixing unit 41.

Further, the coating apparatus 1 includes a distance measuring unit 50a, a nozzle height measuring unit 50b, a second moving mechanism 60, a nozzle waiting unit 70 and a control device 100.

The distance measuring unit 50a is disposed above the substrate W (in the lift mechanism 40 in this embodiment). The distance measuring unit 50a is configured to measure a distance from the distance measuring unit 50a to an upper surface of the substrate W. The nozzle height measuring unit 50b is disposed below the substrate W (in the mounting table 10 in this embodiment) and configured to measure a distance from the nozzle height measuring unit 50b to a lower end surface of the slit nozzle 30.

The measurement results obtained at the distance measuring unit 50a and the nozzle height measuring unit 50b are transmitted to the control device 100 (which will be described later) and are used to set the height of the slit nozzle 30 in the course of a coating process. In some embodiments, laser displacement meters may be used as the distance measuring unit 50a and the nozzle height measuring unit 50b.

The second moving mechanism 60 is configured to move the nozzle waiting unit 70 in the horizontal direction. The second moving mechanism 60 includes a support unit 61 configured to horizontally support the nozzle waiting unit 70 and a driving unit 62 configured to horizontally move the support unit 61.

The second moving mechanism 60 moves the support unit 61 in the horizontal direction through the use of the driving unit 62, thereby horizontally moving the nozzle waiting unit 70 mounted on the support unit 61.

In the nozzle waiting unit 70, the slit nozzle 30 waits until a subsequent coating operation is started after finishing the coating operation. In the nozzle waiting unit 70, a plurality of processes are performed. The processes include a supplement process of supplementing a coating liquid into the slit nozzle 30, and a priming process of wiping the coating liquid R adhered to the discharge port 6 of the slit nozzle 30 to put the discharge port 6 in order. A configuration of the nozzle waiting unit 70 will be described later.

The control device 100 controls the entire operation of the coating apparatus 1. The control device 100 may be, e.g., a computer, and includes a control unit (not shown) and a storage unit (not shown). The storage unit stores a program for controlling various kinds of processes such as a coating process and the like. The control unit reads out and executes the program stored in the storage unit, thus controlling the operation of the coating apparatus 1.

Further, the program may be stored in a computer-readable recording medium and may be installed from the recording medium into the storage unit of the control device 100. Examples of the computer-readable recording medium may include a hard disc (HD), a flexible disc (FD), a compact disc (CD), a magneto-optical disc (MO), a memory card, and so forth.

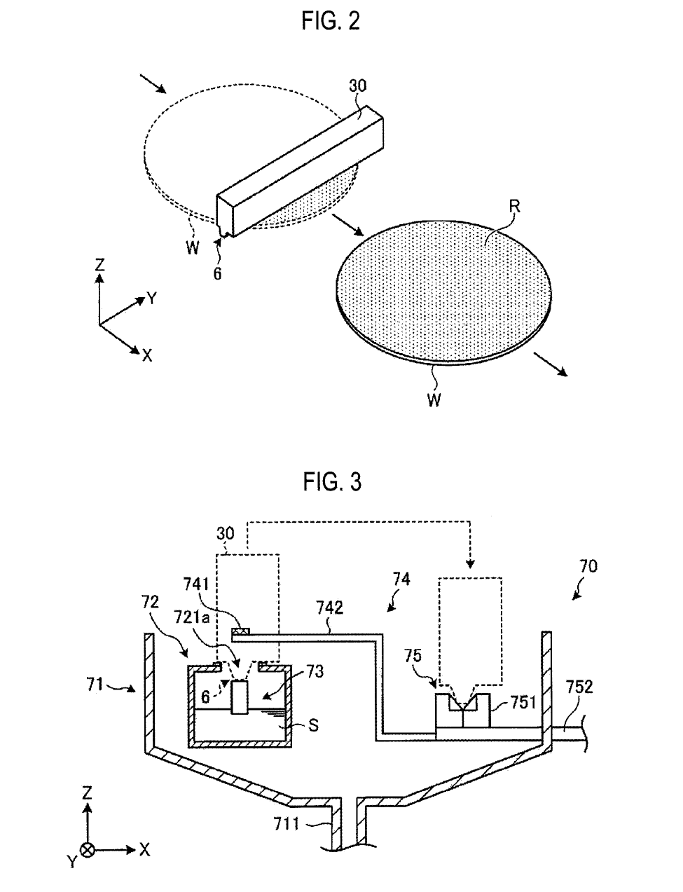

Next, the outline of the coating process performed by the coating apparatus 1 will be described with reference to FIG. 2. FIG. 2 is a view schematically showing the coating process.

As shown in FIG. 2, the slit nozzle 30 is an elongated member that extends in the direction (the Y-axis direction) orthogonal to the moving direction (the X-axis direction) of the substrate W by the first moving mechanism 20 (see FIG. 1). The slit nozzle 30 discharges the coating liquid R from the slit-like discharge port 6 formed at the lower side thereof.

The coating apparatus 1 initially exposes a small amount of coating liquid R from the discharge port 6 of the slit nozzle 30. Then, the coating apparatus 1 controls an internal pressure of the slit nozzle 30 to keep a state where the coating liquid R has been exposed from the discharge port 6.

Subsequently, the coating apparatus 1 lowers the slit nozzle 30 using the lift mechanism 40 (see FIG. 1) and exposes the coating liquid R from the discharge port 6 contacting the upper surface of the substrate W. A lowering distance of the slit nozzle 30 is set based on the measurement results of the distance measuring unit 50a and the nozzle height measuring unit 50b.

Thereafter, the coating apparatus 1 moves the substrate W in the horizontal direction (the X-axis direction in FIG. 1) using the first moving mechanism 20 (see FIG. 1). Thus, the coating liquid R is widely coated on the upper surface of the substrate W so that a coating film is formed.

In this way, the coating apparatus 1 moves the substrate W in the horizontal direction while exposing the coating liquid R from the slit nozzle 30 contacting the upper surface of the substrate W, thereby widely coating the coating liquid R on the substrate W and forming the coating film. The coating film formed on the substrate W by the coating apparatus 1 has a thickness of 10 μm or more.

Upon completion of the coating process, the slit nozzle 30 moves to the nozzle waiting unit 70 where the slit nozzle 30 waits until a subsequent coating process is started. The movement of the slit nozzle 30 is performed by the lift mechanism 40 and the second moving mechanism 60.

Now, a configuration of the nozzle waiting unit 70 will be described with reference to FIG. 3. FIG. 3 is a schematic view showing a configuration of the nozzle waiting unit 70 of the coating apparatus 1 according to the first embodiment.

As shown in FIG. 3, the nozzle waiting unit 70 of the coating apparatus 1 according to the first embodiment includes a drain pan 71, a solvent reservoir 72, a sealing unit 73, a scraping unit 74 and a priming mechanism 75.

The drain pan 71 is a large vessel whose top portion is opened. The drain pan 71 is made of a metal, e.g., stainless steel. The solvent reservoir 72, the sealing unit 73, the scraping unit 74 and a priming unit 751 of the priming mechanism 75 are accommodated within the drain pan 71.

The drain pan 71 configured as above includes a drain port 711 formed in a bottom portion thereof. The drain pan 71 receives the coating liquid R dropped from the slit nozzle 30 during the supplement process of the coating liquid R or the priming process (which will be described later) and drains the received coating liquid R to the outside through the drain port 711.

Upon completion of the coating process, the slit nozzle 30 moves to the solvent reservoir 72 and waits in the solvent reservoir 72. The solvent reservoir 72 is a vessel that stores a solvent S such as a thinner which dissolves the coating liquid R. The interior of the solvent reservoir 72 is kept in a solvent atmosphere by the solvent S. The discharge port 6 of the slit nozzle 30 is exposed to the solvent atmosphere, thus preventing the coating liquid R existing within the slit nozzle 30 from being dried in the air.

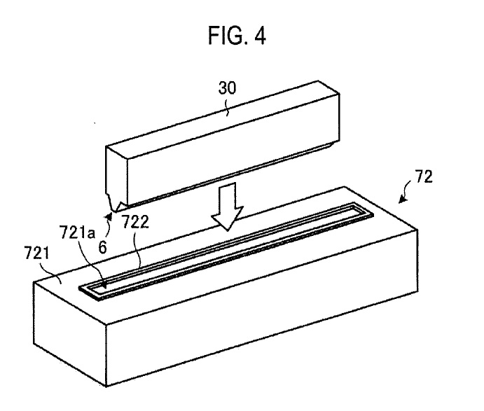

Now, a configuration of the solvent reservoir 72 will be described with reference to FIG. 4. FIG. 4 is a schematic view of the solvent reservoir 72.

As shown in FIG. 4, the solvent reservoir 72 is an elongated vessel having a slit-like opening 721a formed in an upper surface 721 thereof. The solvent S (see FIG. 3) is stored in the solvent reservoir 72, whereby the interior of the solvent reservoir 72 is maintained in the solvent atmosphere. A resin member 722 is installed along a periphery of the opening 721a. This makes it possible to prevent the slit nozzle 30 from being brought into contact with the periphery of the opening 721a and getting damaged when the discharge port 6 of the slit nozzle 30 is inserted into the opening 721a.

The sealing unit 73 is configured to seal the discharge port 6 by bring into contact with the discharge port 6 of the slit nozzle 30. The sealing unit 73 is disposed within the solvent reservoir 72 as shown in FIG. 3.

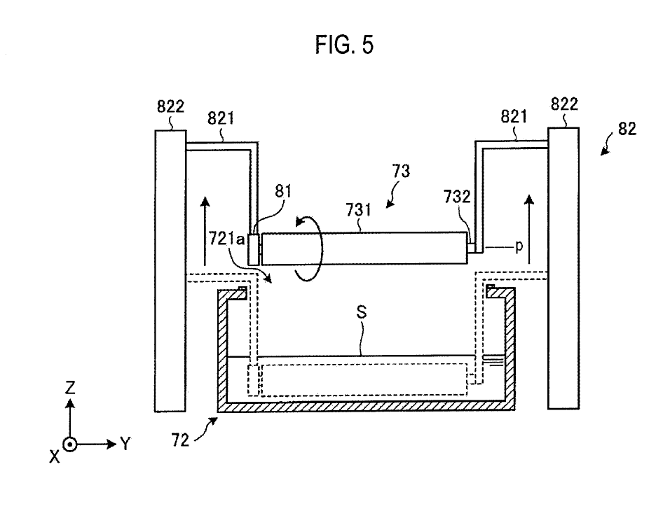

The sealing unit 73 is movable upward and downward and is rotatable about a center axis thereof. A detailed configuration of the sealing unit 73 will be described with reference to FIG. 5. FIG. 5 is a schematic view of the sealing unit 73.

As shown in FIG. 5, the sealing unit 73 includes a body 731 and a shaft 732. The body 731 is an elongated member that extends in the longitudinal direction (the Y-axis direction in FIG. 5) of the discharge port 6 of the slit nozzle 30. The shaft 732 is installed to extend through the body 731 in the longitudinal direction of the body 731.

The sealing unit 73 is connected to a rotating mechanism 81 through one end of the shaft 732 such that the sealing unit 73 is rotated about the center axis p of the shaft 732 with the operation of the rotating mechanism 81 as shown in FIG. 5. In this embodiment, the rotating mechanism 81 is disposed outside the drain pan 71.

In some embodiments, the rotating mechanism 81 may rotate the sealing unit 73 using a drive source such as a motor, but is not limited thereto. Alternatively, the sealing unit 73 may be rotated by a link part that is movable with a lifting operation of a lift mechanism 82 (which will be described later).

The body 731 of the sealing unit 73 is made of resin such as a rubber which seldom causes damages to the discharge port 6. In this embodiment, the entirety of the body 731 is made of resin. In some embodiments, at least a portion of the body 731 which is brought into contact with the discharge port 6 may be made of resin.

As shown in FIG. 5, the lift mechanism 82 is connected to the sealing unit 73. The lift mechanism 82 includes a support member 821 configured to support the shaft 732 of the sealing unit 73, and a lift unit 822 configured to move the support member 821 in the vertical direction.

In the coating apparatus 1, as shown in FIG. 5, the sealing unit 73 is moved downward by the lift mechanism 82 so that it can be completely immersed into the solvent S within the solvent reservoir 72. Further, in the coating apparatus 1, the sealing unit 73 is moved upward by the lift mechanism 82 so that it can be taken out of the solvent reservoir 72. As set forth above, the lift mechanism 82 corresponds to one example of an immersing mechanism that immerses the sealing unit 73 into the solvent S stored in the solvent reservoir 72.

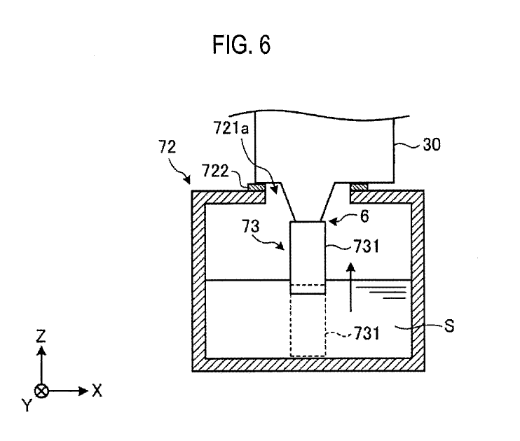

Next, an operation of sealing the discharge port 6, which is performed by the sealing unit 73, will be described with reference to FIG. 6. FIG. 6 is a view showing the sealing operation performed by the sealing unit 73.

As described above, the sealing unit 73 is disposed within the solvent reservoir 72 used as a waiting place of the slit nozzle 30. The supplement process of the coating liquid R to the slit nozzle 30 is carried out inside the solvent reservoir 72.

In some embodiments, when the slit nozzle 30 is waiting in the solvent reservoir 72, the body 731 of the sealing unit 73 may be wholly immersed in the solvent S of the solvent reservoir 72. With this configuration, even if the coating liquid R is dropped from the slit nozzle 30 in the waiting state, the dropped coating liquid R does not adhere to the sealing unit 73 and doses not contaminate the sealing unit 73. Alternatively, when the slit nozzle 30 is in the waiting state, the sealing unit 73 may be partially immersed in the solvent S or may be wholly exposed from the solvent S.

The supplement process of the coating liquid R is started, for example, when a subsequent substrate W is loaded into the coating apparatus 1. At the start of the supplement process of the coating liquid R, as indicated by an upward-oriented arrow in FIG. 6, the lift mechanism 82 (see FIG. 5) lifts the sealing unit 73 to make the sealing unit 73 be in contact with the discharge port 6 of the slit nozzle 30. Thus, the discharge port 6 of the slit nozzle 30 is sealed by the sealing unit 73.

When the slit nozzle 30 is moved downward to make the discharge port 6 of the slit nozzle 30 be in contact with the sealing unit 73 in a state where the sealing unit 73 is wholly immersed in the solvent S, air bubbles may be mixed into the coating liquid R when supplementing the coating liquid R to the slit nozzle 30. To address this, in the coating apparatus 1 according to the present disclosure, the sealing unit 73 is lifted up such that a portion of the sealing unit 73 which makes a contact with the slit nozzle 30 is exposed from the solvent S. Thereafter, the portion of the sealing unit 73 is brought into contact with the discharge port 6 of the slit nozzle 30, which prevents the air bubbles from being mixed into the coating liquid R.

The downward movement of the slit nozzle 30 is restricted by the resin member 722 installed along the periphery of the opening 721a of the solvent reservoir 72. In this case, assuming that a position of the sealing unit 73 is fixed, it is necessary to accurately set the position of the sealing unit 73 so as to reliably seal the discharge port 6. However, as described above, since the sealing unit 73 is configured to be moved up and down by the lift mechanism 82, there is no need to accurately set the position of the sealing unit 73.

In some embodiments, the coating apparatus 1 may include a sensing unit configured to sense a position where the sealing unit 73 is brought into contact with the discharge port 6 of the slit nozzle 30. The sensing unit may be provided in the sealing unit 73 or the lift mechanism 82. In some embodiments, the support member 821 of the lift mechanism 82 may support the shaft 732 of the sealing unit 73 using an elastic member such as a spring. These configurations enable the sealing unit 73 to reliably seal the discharge port 6 of the slit nozzle 30.

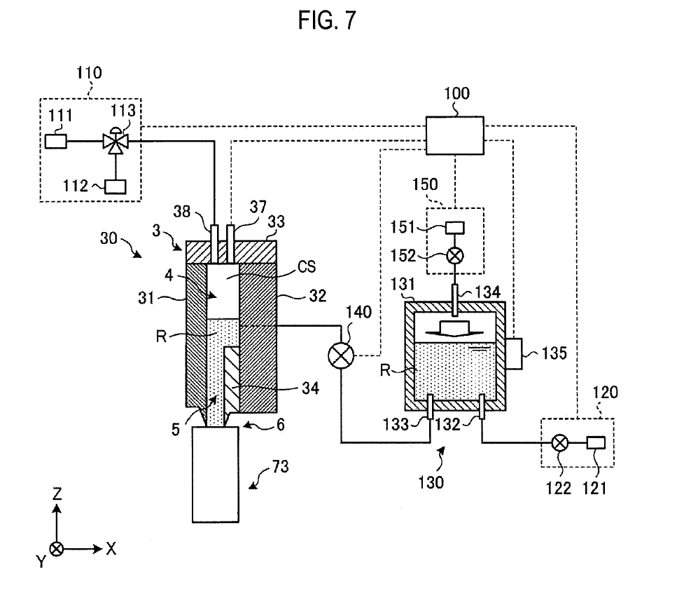

After the discharge port 6 of the slit nozzle 30 is sealed in this manner, the supplement process of the coating liquid R into the slit nozzle 30 is initiated. Now, the supplement process of the coating liquid R into the slit nozzle 30 will be described with reference to FIG. 7. FIG. 7 is a schematic view showing a configuration of the slit nozzle 30 and configurations of units connected thereto.

As shown in FIG. 7, the slit nozzle 30 includes an elongated body 3, a retaining section 4 defined inside the body 3 and configured to retain the coating liquid R therein, and the discharge port 6 through which the coating liquid R fed from the retaining section 4 through a slit-like flow path 5 is discharged.

The body 3 of the slit nozzle 30 includes a first wall portion 31 which defines a front side of the body 3, a second wall portion 32 which defines rear and lateral sides of the slit nozzle 30, a cover part 33 which defines a ceiling of the slit nozzle 30, and an elongated land part 34 which is disposed on a surface of the second wall portion 32 facing the first wall portion 31.

The slit nozzle 30 includes an internal space defined by the first wall portion 31, the second wall portion 32, the cover part 33 and the land part 34. In the internal space, an upper space defined between the first wall portion 31 and the second wall portion 32 corresponds to the retaining section 4. A lower space which is defined between the first wall portion 31 and the land part 34 and has a width smaller than that of the retaining section 4 corresponds to the flow path 5. The width of the flow path 5 remains constant. A width of the discharge port 6 formed in the leading end of the flow path 5 is equal to that of the flow path 5.

The width of the flow path 5 is set to such a value that, when an internal pressure of the retaining section 4 is made equal to an external pressure of the retaining section 4, a surface tension of the coating liquid R becomes smaller than the gravity acting on the coating liquid R, whereby the coating liquid R is dropped from the discharge port 6 at a specified flow rate. Specifically, the width of the flow path 5 may be set by a pre-test in which a state of the coating liquid R is evaluated while changing the width of the flow path 5, a viscosity of the coating liquid R and a material of the slit nozzle 30.

A pressure measuring unit 37 and a pressure regulating pipe 38 are installed in the cover part 33 to extend through the cover part 33. The pressure measuring unit 37 is configured to measure an internal pressure of a closed space CS surrounded by a liquid surface of the coating liquid R retained in the retaining section 4 and inner wall surfaces of the retaining section 4. The pressure regulating pipe 38 is connected to a pressure regulating unit 110 which is configured to regulate the internal pressure of the closed space CS. The pressure measuring unit 37 is electrically connected to the control device 100. The measurement results of the pressure measuring unit 37 are sent to the control device 100.

In some embodiments, the pressure measuring unit 37 may be installed in any position insofar as the pressure measuring unit 37 communicates with the closed space CS inside the slit nozzle 30. As an example, the pressure measuring unit 37 may be installed to extend through the first wall portion 31.

The pressure regulating unit 110 includes an exhaust unit 111 such as a vacuum pump, a gas supply source 112 configured to supply a gas such as N₂, and a switching valve 113 connected to the pressure regulating pipe 38. The pressure regulating unit 110 is electrically connected to the control device 100. In response to a command transmitted from the control device 100, the pressure regulating unit 110 adjusts an opening degree of the switching valve 113 such that one of the exhaust unit 111 and the gas supply source 112 is selectively connected to the pressure regulating pipe 38, thus regulating an amount of a gas exhausted from the retaining section 4 or regulating an amount of a gas supplied into the retaining section 4. With this configuration, the coating apparatus 1 can regulate the internal pressure of the retaining section 4 as the measurement results of the pressure measuring unit 37 to become a specified value.

In this configuration, the retaining section 4 is evacuated such that the internal pressure of the retaining section 4 becomes lower than the external pressure of the retaining section 4. Thus, the coating liquid R existing within the retaining section 4 is pulled upward, which makes it possible to prevent the coating liquid R from being dropped from the discharge port 6. Further, a gas is supplied into the retaining section 4 to pressurize the coating liquid R remaining in the retaining section 4 after the coating process of the coating liquid R. This makes it possible to discharge the coating liquid R out of the retaining section 4, or purge the interior of the retaining section 4.

The configuration of the pressure regulating unit 110 is not limited those as described above. In some embodiments, the configuration of the pressure regulating unit 110 may be selected as appropriate as long as the pressure regulating unit 110 can control the internal pressure of the retaining section 4. As an example, each of the exhaust unit 111 and the gas supply source 112 may include a respective pressure regulating pipe 38 and a respective pressure regulating valve and may be independently coupled to the cover part 33.

As shown in FIG. 7, the slit nozzle 30 is connected to a coating liquid supply system that includes a coating liquid supply unit 120, an intermediate tank 130, a supply pump 140 and a pressurizing unit 150.

The coating liquid supply unit 120 includes a coating liquid supply source 121 and a valve 122. The coating liquid supply source 121 is coupled to the intermediate tank 130 through the valve 122 and is configured to supply the coating liquid R to the intermediate tank 130. The coating liquid supply unit 120 is electrically connected to the control device 100. Under the control of the control device 100, opening and closing operations of the valve 122 are controlled.

The intermediate tank 130 is located between the coating liquid supply unit 120 and the slit nozzle 30. The intermediate tank 130 includes a tank part 131, a first supply pipe 132, a second supply pipe 133, a third supply pipe 134 and a liquid surface sensor 135.

The tank part 131 stores the coating liquid R therein. The first supply pipe 132 and the second supply pipe 133 are installed in the bottom of the tank part 131. The first supply pipe 132 is coupled to the coating liquid supply source 121 through the valve 122. The second supply pipe 133 is coupled to the slit nozzle 30 through the supply pump 140.

The third supply pipe 134 is connected to the pressurizing unit 150. The pressurizing unit 150 includes a gas supply source 151 configured to supply a gas such as N₂ and a valve 152. The pressurizing unit 150 pressurizes the interior of the tank part 131 by supplying the N₂ gas into the tank part 131. The pressurizing unit 150 is electrically connected to the control device 100 by which opening and closing operations of the valve 152 are controlled.

The liquid surface sensor 135 is configured to sense a liquid surface of the coating liquid R stored in the tank part 131. The liquid surface sensor 135 is electrically connected to the control device 100. The results sensed at the liquid surface sensor 135 are sent to the control device 100.

The supply pump 140 is installed in the middle of the second supply pipe 133 and is configured to supply the coating liquid R, which is supplied from the intermediate tank 130, to the slit nozzle 30. The supply pump 140 is electrically connected to the control device 100 such that an amount of the coating liquid R supplied to the slit nozzle 30 is controlled by the control device 100.

The coating apparatus 1 operates the supply pump 140 to supplement the coating liquid R from the intermediate tank 130 to the retaining section 4 of the slit nozzle 30. At this time, the internal pressure of the retaining section 4 is regulated to a negative pressure by the pressure regulating unit 110. The coating apparatus 1 performs the supplement process of the coating liquid R while gradually reducing the internal pressure of the retaining section 4 which is regulated to the negative pressure (i.e., while increasing a degree of vacuum).

As described above, when the coating liquid R is supplemented into the retaining section 4 of the slit nozzle 30, the coating apparatus 1 seals the discharge port 6 of the slit nozzle 30 with the sealing unit 73, thus preventing the coating liquid R from being leaked from the discharge port 6 during the supplement process.

Further, according to the coating apparatus 1 as described above, the internal pressure of the retaining section 4 is converted to the negative pressure by controlling the pressure regulating unit 110. The coating liquid R is supplied into the retaining section 4 while gradually reducing the internal pressure of the retaining section 4 kept in the negative pressure. This prevents the leakage of the coating liquid R more reliably.

Specifically, if the coating liquid R is supplied into the retaining section 4 so that the liquid surface of the coating liquid R is increased, a head pressure acting on the discharge port 6, which is caused by the supplied coating liquid R, becomes higher. During that time, if the internal pressure of the retaining section 4 and the external pressure of the retaining section 4 are kept constant with no change, the force by which the coating liquid R is pushed upward is relatively weaken as much as the head pressure increases. For that reason, the coating liquid R may be leaked from the discharge port 6 sealed by the sealing unit 73.

According to the coating apparatus 1 of the present disclosure, the internal pressure of the retaining section 4 is gradually increased by the pressure regulating unit 110 in conformity with an increase in height of the liquid surface of the coating liquid R existing within the retaining section 4. This increases the force by which the coating liquid R is pushed upward. Therefore, during the supplement process of the coating liquid R, it is possible to reliably prevent the coating liquid R from being leaked from the discharge port 6 sealed by the sealing unit 73.

In some embodiments, the coating apparatus 1 may change the internal pressure of the retaining section 4 at a predetermined time. Alternatively, the coating apparatus 1 may include an additional detection unit configured to detect the liquid surface of the coating liquid R existing within the retaining section 4. The internal pressure of the retaining section 4 may be changed based on the detection results obtained at the additional detecting unit.

Referring again to FIG. 3, the scraping unit 74 will be described. As shown in FIG. 3, the scraping unit 74 includes a pad 741 made of a resin, and a support member 742 configured to support the pad 741. The pad 741 is disposed above the opening 721a of the solvent reservoir 72.

The support member 742 of the scraping unit 74 is fixed to a movable part (not shown) of the priming mechanism 75. Thus, during the priming process (which will be described later), the scraping unit 74 moves in the Y-axis direction together with the priming unit 751. The pad 741 also moves in the Y-axis direction so that the pad 741 is brought into contact with the sealing unit 73, thereby scraping the coating liquid R adhering to the sealing unit 73.

In this way, according to the coating apparatus 1 of the present disclosure, the coating liquid R adhering to the sealing unit 73 is scraped by the scraping unit 74, thus preventing the coating liquid R from being accumulated in the sealing unit 73.

As shown in FIG. 3, the discharge port 6 of the slit nozzle 30 is brought into contact with the top surface of the sealing unit 73. Thus, the coating liquid R adheres to the top surface of the sealing unit 73. In order to remove the coating liquid R adhering to the sealing unit 73, it is generally necessary to make the top surface of the sealing unit 73 be in contact with the scraping unit 74.

However, if the coating liquid R is scraped from the top surface of the sealing unit 73, the scraped coating liquid R may re-adhere to the sealing unit 73. Occasionally, the scrapped coating liquid R may be scattered toward and adhere to peripheral devices such as the solvent reservoir 72 and the priming mechanism 75. The scrapped coating liquid R adhering to the sealing unit 73 and the peripheral devices may be not drained through the drain port 711 but remains within the drain pan 71. This causes the coating liquid R to be dried into particles, thereby contaminating the surroundings. In addition, the adhesion of the coating liquid R to the sealing unit 73 and the peripheral devices may defile the coating apparatus 1.

To address this, in the coating apparatus 1 according to the first embodiment, the sealing unit 73 is turned down along the center axis p by the rotating mechanism 81 (see an arrow indicated in FIG. 5) so that the coating liquid R adhering to the sealing unit 73 is located in the lower side of the sealing unit 73. Under this circumstance, the scraping operation is performed by the scraping unit 74.

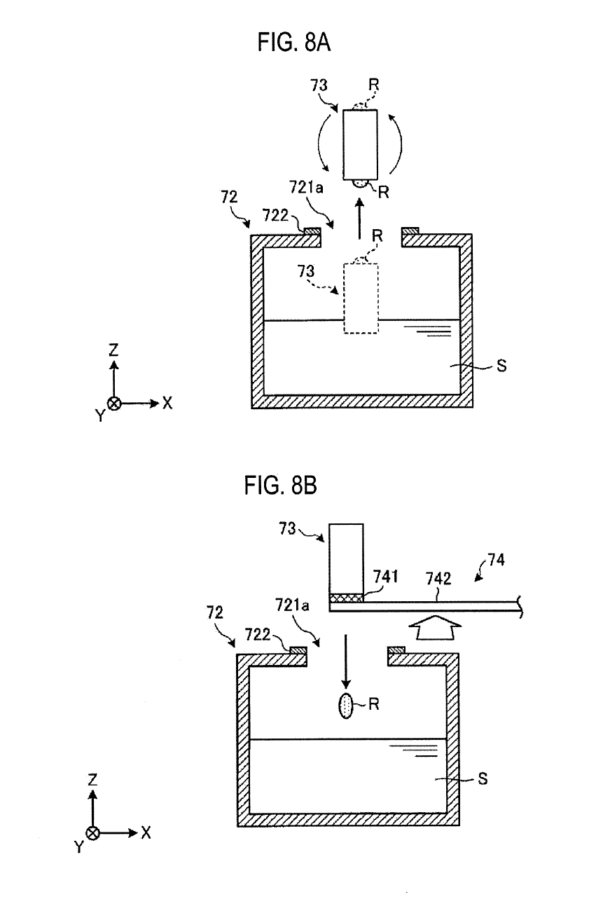

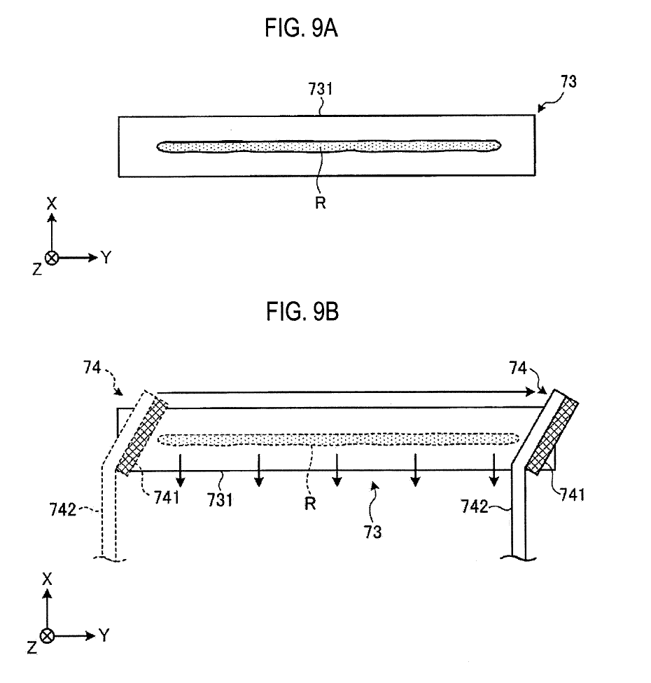

FIGS. 8A and 8B are views showing operations of the cleaning the sealing unit 73. FIG. 9A is a view showing the coating liquid R adhering to the sealing unit 73. FIG. 9B is a view showing the scraping operation performed by the scraping unit 74. The cleaning operations of the sealing unit 73 shown in FIGS. 8A and 8B are performed under the control of the control device 100.

As shown in FIG. 8A, after the supplement process is performed, the coating liquid R adheres to the top surface of the body 731 of the sealing unit 73. The coating apparatus 1 moves the sealing unit 73 upward using the lift mechanism 82, thereby taking the sealing unit 73 out of the solvent reservoir 72 and positioning the sealing unit 73 above the solvent reservoir 72.

The coating apparatus 1 rotates the sealing unit 73 using the rotating mechanism 81 to turn (or invert) upside down a portion of the sealing unit 73 to which the coating liquid R adheres. Thus, the coating liquid R adhering to the top surface of the sealing unit 73 is turned to be positioned at the lower side of the sealing unit 73 (see FIG. 8A).

While in this embodiment, the coating liquid R has been described to be moved to the lower side of the body 731 in the sealing unit 73, the present disclosure is not limited thereto. In some embodiments, the coating apparatus 1 may move the coating liquid R to at least below the uppermost section of the body 3, and in some embodiments, to the lower half section of the body 731 as shown in FIG. 9A.

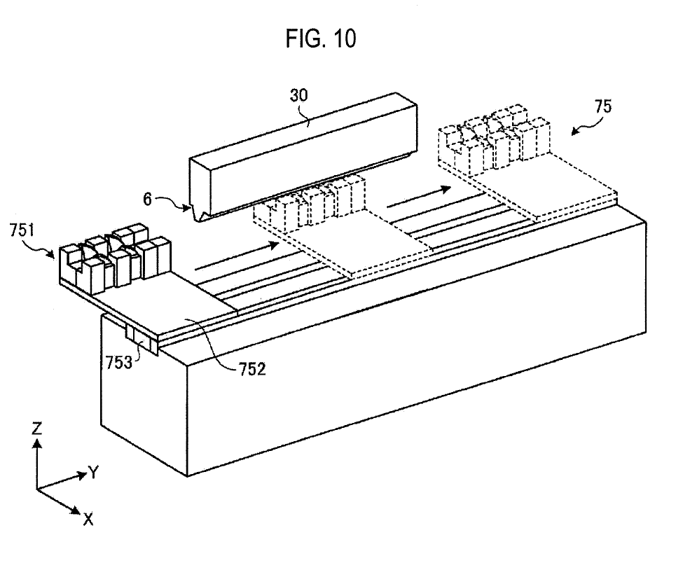

Subsequently, as shown in FIGS. 8B and 9B, the coating apparatus 1 scrapes the coating liquid R located at the lower side of the sealing unit 73 using the scraping unit 74. By virtue of a driving unit 753 (see FIG. 10) of the priming mechanism 75, the scraping unit 74 is moved in the longitudinal direction of the sealing unit 73 (in the Y-axis direction) together with the priming unit 751. At this time, the pad 741 of the scraping unit 74 is brought into contact with the lower side of the sealing unit 73, thus scraping the coating liquid R adhering thereto. Since the sealing unit 73 is positioned above the solvent reservoir 72, the coating liquid R scraped from the sealing unit 73 is dropped into the solvent S inside the solvent reservoir 72.

As described above, in the coating apparatus 1 according to the first embodiment, the coating liquid R adhering to the sealing unit 73 is turned to be positioned at the lower side of the sealing unit 73. Thereafter, the coating liquid R adhering to the lower side of the sealing unit 73 is scraped by the pad 741 of the scraping unit 74. This prevents the scraped coating liquid R from re-adhering to the sealing unit 73. Further, the scraped coating liquid R is restrained from scattering to the surroundings, which makes it possible to prevent the scrapped coating liquid R from adhering to the peripheral devices. This prevents the surroundings from being contaminated due to the particles caused by the dried coating liquid R. Furthermore, no damage to the sealing unit 73 and the peripheral devices occurs.

Therefore, according to the coating apparatus 1, it is possible to reliably remove the coating liquid R adhering to the sealing unit 73, while preventing the contamination of the surroundings and the defilement of the coating apparatus 1.

Further, in the coating apparatus 1 according to the first embodiment, the coating liquid R scraped by the scraping unit 74 is dropped into the solvent reservoir 72. This makes the coating liquid R hard to adhere to the exterior of the solvent reservoir 72, the priming mechanism 75 and the drain pan 71, thus preventing the coating apparatus 1 from being defiled for a long period of time.

Upon completion of the cleaning process of the sealing unit 73, the sealing unit 73 is lowered by the lift mechanism 82 and is immersed into the solvent S again. Therefore, even if the coating liquid R remains in the sealing unit 73, it is possible to dissolve the coating liquid R with the solvent S and to remove the coating liquid R from the sealing unit 73.

The slit nozzle 30 which has undergone the supplement process of the coating liquid R is moved to the priming mechanism 75 (see FIG. 3) where the slit nozzle 30 is subjected to a priming process.

In the priming process, the priming unit 751 is moved in the longitudinal direction of the slit nozzle 30 (in the Y-axis direction) while bring the discharge port 6 of the slit nozzle 30 into contact with the priming unit 751, thus wiping the coating liquid R adhering to the discharge port 6. The priming process allows the discharge port 6 to be put in order, thus stably discharging the coating liquid R.

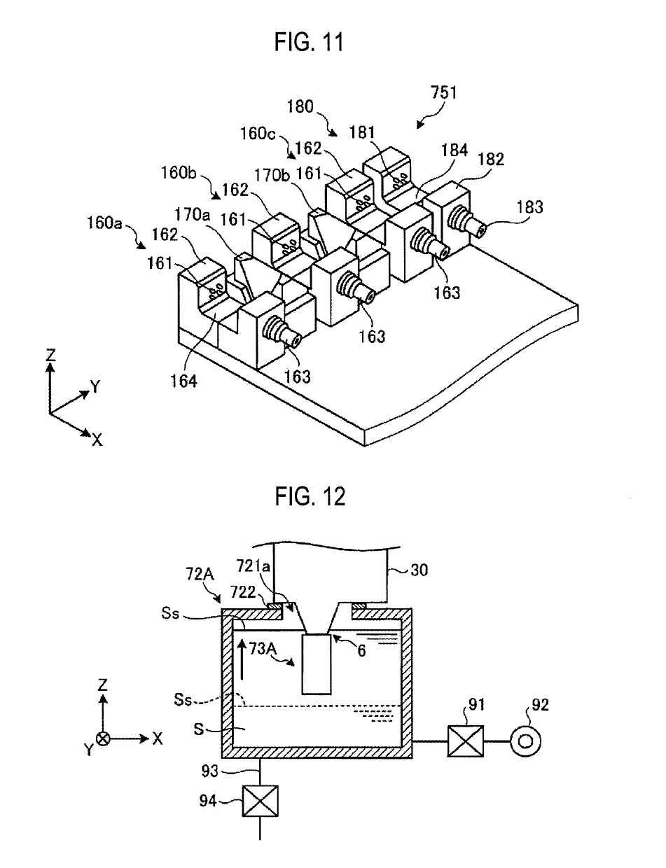

Next, a configuration of the priming mechanism 75 will be described with reference to FIGS. 10 and 11. FIG. 10 is a schematic view showing the configuration of the priming mechanism 75. FIG. 11 is a schematic view showing a configuration of the priming unit 751 provided in the priming mechanism 75.

As shown in FIG. 10, the priming mechanism 75 includes the priming unit 751, a support unit 752 configured to horizontally support the priming unit 751, and the driving unit 753 configured to move the support unit 752 in the longitudinal direction of the slit nozzle 30 (in the Y-axis direction). In some embodiments, a portion of the support unit 752 and the driving unit 753 may be disposed outside the drain pan 71.

As shown in FIG. 11, the priming unit 751 includes a plurality of cleaning solution supply mechanisms 160a to 160c configured to supply a cleaning solution to the discharge port 6 of the slit nozzle 30 and the peripheral portion thereof, contact members 170a and 170b formed to bring into contact with the discharge port 6 of the slit nozzle 30 and the peripheral portion thereof, and a gas supply mechanism 180 configured to supply a drying gas to the discharge port 6 of the slit nozzle 30 and the peripheral portion thereof.

In the priming unit 751, the cleaning solution supply mechanism 160a, the contact member 170a, the cleaning solution supply mechanism 160b, the contact member 170b, the cleaning solution supply mechanism 160c and the gas supply mechanism 180 are arranged in a line in the named order along the positive Y-axis direction as shown in FIG. 11.

Each of the cleaning solution supply mechanisms 160a to 160c includes a plurality of cleaning solution nozzles 161 configured to supply a cleaning solution (e.g., a resist solution solvent) to the discharge port 6 of the slit nozzle 30 and the peripheral portion thereof, and a support body 162 configured to support the cleaning solution nozzle 161. The plurality of cleaning solution nozzles 161 in each of the cleaning solution supply mechanisms 160a to 160c is coupled to a cleaning solution supply pipe (not shown) through a pipe connector 163 installed on a lateral side of the support body 162. The cleaning solution supply pipe is in communication with a cleaning solution supply source (not shown) that stores the cleaning solution therein.

A groove 164 is formed in the central region of an upper surface of each of the support bodies 162. The cleaning solution nozzles 161 are installed to protrude inwardly from opposite inner surfaces of the respective groove 164. The groove 164 is formed to have such a size that the slit nozzle 30 can pass through the groove 164. In this arrangement, the cleaning solution is injected from each of the cleaning solution nozzles 161 toward the discharge port 6 of the slit nozzle 30 and the peripheral portion thereof, which pass through the groove 164.

Examples of a material of each of the contact members 170a and 170b may include a rubber such as a fluorine-containing elastomer, which is slidably movable on the slit nozzle 30 while bring into contact with the slit nozzle 30 during the cleaning process of the slit nozzle 30. A shape of an upper portion of the contact member 170a is tailored to meet that of the lower portion (i.e., the discharge port 6) of the slit nozzle 30.

The gas supply mechanism 180 includes a plurality of gas nozzles 181 configured to supply a drying gas (e.g., an inert gas such as a nitrogen gas) to the discharge port 6 of the slit nozzle 30 and the peripheral portion thereof, and a support body 182 configured to support the gas nozzles 181. The plurality of gas nozzles 181 is coupled to a gas supply pipe (not shown) through a pipe connector 183 installed on a lateral side of the support body 182. The gas supply pipe is in communication with a gas supply source (not shown) that stores the drying gas therein.

A groove 184 is formed in the central region of an upper surface of the support body 182. The gas nozzles 181 are installed to protrude inwardly from opposite inner surfaces of the groove 184. The groove 184 is formed to have such a size that the slit nozzle 30 can pass through the groove 184. The drying gas is injected from each of the gas nozzles 181 toward the discharge port 6 of the slit nozzle 30 and the peripheral portion thereof, which pass through the groove 184.

First, in order to perform the priming process using the priming mechanism 75, the slit nozzle 30 is moved to a position where the discharge port 6 of the slit nozzle 30 and the peripheral portion thereof are brought into contact with the contact members 170a and 170b.

Subsequently, the cleaning solution is discharged from the cleaning solution nozzles 161 of each of the cleaning solution supply mechanisms 160a to 160c, and the drying gas is injected from the gas nozzles 181 of the gas supply mechanism 180. Simultaneously, the priming unit 751 is moved by the driving unit 753 at a predetermined speed along the longitudinal direction of the slit nozzle 30.

Thus, the coating liquid R adhering to the discharge port 6 of the slit nozzle 30 and the peripheral portion thereof is wiped by the contact members 170a and 170b so that the discharge port 6 is put in order.

Upon completion of the priming process of the priming mechanism 75, the coating process as described with reference to FIG. 2 is carried out with respect to a subsequent substrate (or wafer) W, which is newly loaded into the coating apparatus 1.

As described above, the coating apparatus 1 according to the first embodiment includes the slit nozzle 30, the first moving mechanism 20, the sealing unit 73, the solvent reservoir 72 and the lift mechanism 82. The discharge port 6 is formed at the lower side of the slit nozzle 30. The coating liquid R is discharged from the discharge port 6. The first moving mechanism 20 moves the slit nozzle 30 relative to the substrate W. The sealing unit 73 is formed to extend in the longitudinal direction of the discharge port 6 such that the top surface of the sealing unit 73 is brought into contact with the discharge port 6, thus sealing the discharge port 6. The solvent S is retained in the solvent reservoir 72. The sealing unit 73 is immersed into the solvent S retained in the solvent reservoir 72 by the lift mechanism 82. Thus, the coating liquid R adhering to the sealing unit 73 is removed by the solvent S.

Therefore, according to the coating apparatus 1 of the first embodiment, it is possible to reliably remove the coating liquid R adhering to the sealing unit 73.

### Second Embodiment

In the first embodiment, examples of the operation of sealing the discharge port 6 with the sealing unit 73 and the operation of cleaning the sealing unit 73 has been described but not limited thereto.

In a second embodiment, other examples of operations of sealing the discharge port 6 with the sealing unit 73 and cleaning the sealing unit 73 will be described. FIG. 12 is a view showing a sealing operation performed by a sealing unit according to the second embodiment. In the following description, the same parts as those described above will be designated by like reference symbols and the duplicate description thereon will be omitted.

Unlike the sealing unit 73 according to the first embodiment, a sealing unit 73A shown in FIG. 12 is fixedly disposed within a solvent reservoir 72A. That is to say, the coating apparatus 1 according to the second embodiment includes none of the rotating mechanism 81 and the lift mechanism 82 shown in FIG. 5. In addition, the sealing unit 73A does not rotate nor moves up and down.

The solvent reservoir 72A of the second embodiment is coupled to a solvent supply source 92 through a valve 91A. The solvent supply source 92 supplies a solvent S into the solvent reservoir 72A through the valve 91. The solvent reservoir 72A is connected to a drain pipe 93. A valve 94 is installed in the middle of the drain pipe 93. The solvent S retained within the solvent reservoir 72A is drained through the drain pipe 93.

In the second embodiment, the coating apparatus 1 lowers the slit nozzle 30 toward the sealing unit 73A with a top surface of the sealing unit 73A exposed from the solvent S so that the discharge port 6 of the slit nozzle 30 is brought into contact with the top surface of the sealing unit 73A. Thus, the discharge port 6 is sealed by the sealing unit 73A. In FIG. 12, a liquid surface Ss of the solvent S during the sealing operation is indicated by a broken line.

Subsequently, the coating apparatus 1 opens the valve 91 for a predetermined period of time such that the solvent S is supplied from the solvent supply source 92 into the solvent reservoir 72A. Then, the liquid surface Ss of the solvent S inside the solvent reservoir 72A goes up (see the liquid surface Ss indicated by a solid line in FIG. 12) so that the sealing unit 73A is completely immersed in the solvent S. That is to say, the portion where the sealing unit 73A is brought into contact with the discharge port 6 of the slit nozzle 30 is kept immersed in the solvent S.

As shown in FIG. 12, the discharge port 6 of the slit nozzle 30 and the peripheral portions thereof are also immersed in the solvent S. This makes it possible to dissolve the coating liquid R adhering to the discharge port 6 and the peripheral portions thereof and to keep clean the discharge port 6 and the peripheral portions thereof.

A set of the valve 91 and the solvent supply source 92 corresponds to one example of an immersing mechanism configured to immerse the sealing unit 73A into the solvent S by increasing the amount of the solvent S retained within the solvent reservoir 72A and elevating the liquid surface Ss of the solvent S.

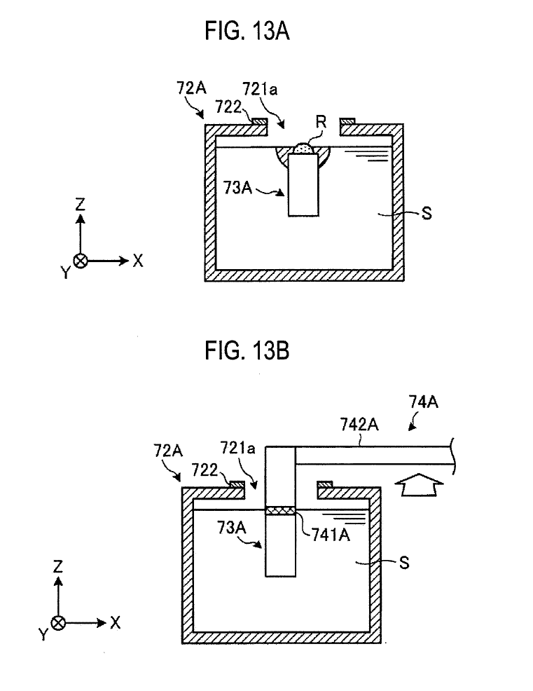

Next, the operation of cleaning the sealing unit 73A according to the second embodiment will be described with reference to FIGS. 13A and 13B. FIG. 13A is a view showing an example of the operation of cleaning the sealing unit 73A according to the second embodiment. FIG. 13B is a view showing another example of the operation of cleaning the sealing unit 73A according to the second embodiment.

As shown in FIG. 13A, the coating liquid R adhering to the top surface of the sealing unit 73A which has undergone the supplement process is dissolved by the solvent S and is removed from the sealing unit 73A.

As described above, after the discharge port 6 of the slit nozzle 30 is sealed by the sealing unit 73A, the portion where the sealing unit 73A is brought into contact with the discharge port 6 of the slit nozzle 30 is completely immersed in the solvent S existing within the solvent reservoir 72A. This makes it possible to remove the coating liquid R from the sealing unit 73A without scattering the coating liquid R adhering to the sealing unit 73A toward the peripheral devices or the like.

Depending on the kind of the coating liquid R, sometimes the coating liquid R may not be removed from the sealing unit 73A by merely immersing the coating liquid R into the solvent S. In some embodiments, as shown in FIG. 13B, the coating liquid R remaining on the top surface of the sealing unit 73A may be scraped by a scraping unit 74A.

The scraping unit 74A shown in FIG. 13B includes a resin pad 741A positioned to face the top surface of the sealing unit 73A, and a support member 742A configured to support the pad 741A. Similar to the scraping unit 74 according to the first embodiment, the support member 742A is fixed to the priming mechanism 75. The scraping unit 74A moves together with the priming unit 751 in the Y-axis direction, thereby scraping the coating liquid R remaining on the top surface of the sealing unit 73A. This makes it possible to reliably remove the coating liquid R from the sealing unit 73A. Further, the scraping operation of the scraping unit 74A is performed within the solvent reservoir 72A, which makes it possible to prevent the scraped coating liquid R from being scattered toward the peripheral devices or the like.

Thereafter, the coating apparatus 1 opens the valve 94 for a predetermined period of time to drain the solvent S existing within the solvent reservoir 72A through the drain pipe 93. Thus, the coating liquid R removed from the sealing unit 73A can be drained to the outside together with the solvent S.

In some embodiments, after the coating liquid R and the solvent S are drained to the outside, the coating apparatus 1 may open the valve 91 for a predetermined period of time to supply the solvent S from the solvent supply source 92 into the solvent reservoir 72A, thereby allowing the sealing unit 73A to be completely immersed in the solvent S again. With this configuration, even if the coating liquid R is dropped from the slit nozzle 30 that is in a waiting mode, there is no possibility that the dropped coating liquid R adheres to the sealing unit 73A and eventually contaminates the sealing unit 73A. Thereafter, the coating apparatus 1 drains the solvent S existing within the solvent reservoir 72A from the drain pipe 93 and performs the operation of sealing the discharge port 6 in a state where at least the portion where the sealing unit 73A is brought into contact with the discharge port 6 of the slit nozzle 30 is exposed from the solvent S.

In some embodiments, after the scraping operation, the coating apparatus 1 may keep the sealing unit 73A completely immersed in the solvent S until the operation of sealing the discharge port 6, without draining the solvent S existing within the solvent reservoir 72A.

### Third Embodiment

In the first embodiment, the sealing operation of the discharge port 6 of the slit nozzle 30 by the sealing unit 73 followed by the supplement process of the coating liquid R in situ has been described to be performed in a state where the portion at which the sealing unit 73 is brought into contact with the discharge port 6 of the slit nozzle 30 is exposed from the solvent S.

In some embodiments, the coating apparatus 1 may perform the supplement process of the coating liquid R after performing a series of operations including: sealing the discharge port 6 of the slit nozzle 30 with the sealing unit 73; lowering the slit nozzle 30 and the sealing unit 73; and immersing the discharge port 6 of the slit nozzle 30 and the sealing unit 73 in the solvent S as shown in FIG. 12.

This configuration prevents air bubbles from being mixed with the coating liquid R when the sealing unit 73 and the discharge port 6 of the slit nozzle 30 are brought into contact with each other. Therefore, it is possible to keep clean the discharge port 6 and the peripheral portions thereof during the supplement process of the coating liquid R.

Upon completion of the supplement process of the coating liquid R, the coating apparatus 1 allows the slit nozzle 30 to wait in a state in which the discharge port 6 of the slit nozzle 30 is sealed by the sealing unit 73 in the solvent S, for example, until a subsequent substrate W is mounted on the substrate holding unit 21.

Thereafter, when the subsequent substrate W is mounted on the substrate holding unit 21, the coating apparatus 1 performs a process of moving the discharge port 6 of the slit nozzle 30 away from the sealing unit 73. In some embodiments, upon completion of the supplement process, the coating apparatus 1 may lift the slit nozzle 30 to move the discharge port 6 of the slit nozzle 30 away from the sealing unit 73. Alternatively, upon completion of the supplement process, the coating apparatus 1 may lift the slit nozzle 30 and the sealing unit 73 such that the portion at which the discharge port 6 of the slit nozzle 30 is brought into contact with the sealing unit 73 is exposed from the solvent S, followed by further moving upward the coating apparatus 1 to move the discharge port 6 of the slit nozzle 30 away from the sealing unit 73.

### Fourth Embodiment

While in the first embodiment, the scraping operation of the scraping unit 74 has been described to be performed in a state where the sealing unit 73 is lifted by the lift mechanism 82 to expose the sealing unit 73 from the solvent S, the present disclosure is not limited thereto. In a fourth embodiment, similar to the second embodiment, the coating apparatus 1 may allow the scraping unit 74A to perform the scraping operation with the sealing unit 73A immersed in the solvent S.

In the fourth embodiment, the coating apparatus 1 performs the supplement process of the coating liquid R with the sealing unit 73A and the discharge port 6 of the slit nozzle 30 immersed in the solvent S, and then lifts the slit nozzle 30. Subsequently, in the coating apparatus 1, the scraping unit 74A shown in FIG. 13B scrapes the coating liquid R remaining on the top surface of the sealing unit 73A. By performing the scraping operation within the solvent reservoir 72A in this manner, it is possible to prevent the scraped coating liquid R from being scattered toward the peripheral devices or the like.

### Fifth Embodiment

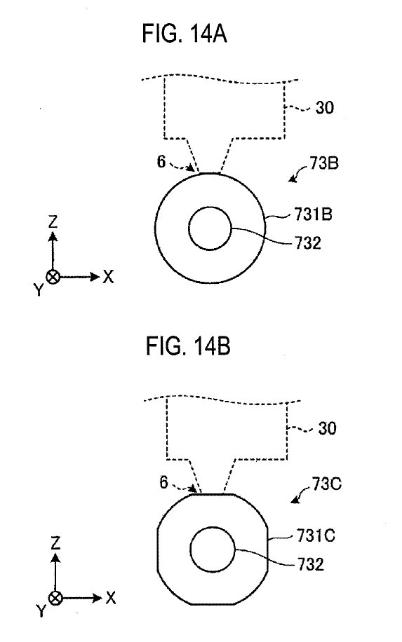

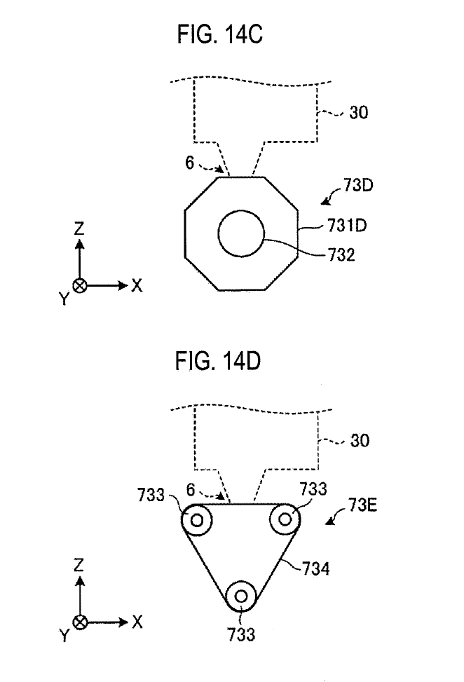

While in the above embodiments, the sealing unit has been described to be formed to have a rectangular cross section when viewed in the longitudinal direction, the present disclosure is not limited thereto. The sealing unit may have various shapes as shown in FIGS. 14A to 14D. FIGS. 14A to 14D are views showing examples of various shapes of the sealing unit.

For example, as shown in FIG. 14A, a body 731B of a sealing unit 73B may be formed to have a circular cross section when viewed in the longitudinal direction (the Y-axis direction). In other words, in the body 731B of the sealing unit 73B, a surface with which the discharge port 6 of the slit nozzle 30 is brought into contact, is not limited to a flat surface but may be a curved surface.

In some embodiments, as shown in FIG. 14B, a body 731C of a sealing unit 73C may be formed to have a circular cross section with a partially-flat surface when viewed in the longitudinal direction (the Y-axis direction), namely a cross section having curved sections and linear sections.

In some embodiments, as shown in FIG. 14C, a body 731D of a sealing unit 73D may be formed to have a polygonal cross section (octagonal in this example) when viewed in the longitudinal direction (the Y-axis direction).

As set forth above, the sealing unit may be formed to have the cross section shape with at least partially linear section when viewed in the longitudinal direction.

In some embodiments, as shown in FIG. 14D, a sealing unit 73E may be configured as a belt conveyor that includes a plurality of rotation rollers 733, a belt 734 stretched between the rotation rollers 733, and a driving unit (not shown) for rotating the rotation rollers 733.

In this case, two of the rotation rollers 733 may be disposed in an upper portion of the sealing unit 73E such that a flat surface is formed by stretching the belt 734 between the two rotation rollers 733. This facilitates the discharge port 6 of the slit nozzle 30 to bring contact with the flat surface of the belt 734. Further, a single rotation roller 733 may be disposed in a lower portion of the sealing unit 73E such that a curved surface is formed by winding the belt 734 around the single rotation roller 733. This facilitates the scarping operation by the scraping unit 74.

While in the above embodiments, the lift mechanism 82 configured to move upward and downward the sealing unit 73 or a set of the valve 91 and the solvent supply source 92 configured to supply the solvent S to the solvent reservoir 72A, has been described to be used as the immersing mechanism, the present disclosure is not limited thereto. In some embodiments, the immersing mechanism may be a lift mechanism configured to move a solvent reservoir upward and downward. With this configuration, it is possible to immerse the sealing unit into a solvent retained in the solvent reservoir.

According to some embodiments of the present disclosure, it is possible to reliably remove a coating liquid adhering to a sealing unit that seals a discharge port of a slit nozzle.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A coating apparatus, comprising:
a slit nozzle provided with a discharge port at a lower side of the slit nozzle, and configured to discharge a coating liquid from the discharge port;
a moving mechanism configured to move the slit nozzle relative to a substrate;
a sealing unit formed to extend along a longitudinal direction of the discharge port, and including a top surface which is brought into contact with the discharge port to seal the discharge port;
a solvent reservoir configured to retain a solvent; and
an immersing mechanism configured to immerse the sealing unit into the solvent retained in the solvent reservoir.

2. The apparatus of claim 1, wherein the immersing mechanism includes a lift mechanism configured to lift and lower the sealing unit.

3. The apparatus of claim 2, wherein the lift mechanism is configured to lift the sealing unit such that the sealing unit makes contact with the discharge port of the slit nozzle.

4. The apparatus of claim 3, further comprising:
a rotating mechanism configured to rotate the sealing unit such that the sealing unit is inverted upside down; and
a scraping unit configured to make contact with a bottom surface of the inverted sealing unit and to scrape the coating liquid adhering to the bottom surface of the inverted sealing unit,
wherein after the sealing unit is lifted by the lift mechanism such that the entire surface of the sealing unit is exposed from the solvent within the solvent reservoir and after the sealing unit is inverted upside down by the rotating mechanism, the scraping unit is brought into contact with the bottom surface of the inverted sealing unit and to scrape the coating liquid adhering to the bottom surface of the inverted sealing unit such that the scrapped coating liquid is dropped into the solvent reservoir.

5. The apparatus of claim 1, wherein at least the top surface of the sealing unit which is brought into contact with the discharge port is made of a resin.

6. The apparatus of claim 1, wherein the sealing unit is formed to have a cross section shape with at least partially linear section when viewed in the longitudinal direction.

7. A method of cleaning a sealing unit, for use in a coating apparatus,
wherein the coating apparatus includes:
a slit nozzle provided with a discharge port at a lower side thereof and configured to discharge a coating liquid from the discharge port;
a sealing unit formed to extend along a longitudinal direction of the discharge port and including a top surface which is brought into contact with the discharge port to seal the discharge port; and
a solvent reservoir configured to retain a solvent,
the method comprising:
exposing at least a portion of the sealing unit making contact with the discharge port from the solvent retained in the solvent reservoir;
bring the discharge port into contact with the top surface of the sealing unit such that the discharge port is sealed by the sealing unit; and
immersing the top surface of the sealing unit into the solvent retained in the solvent reservoir.
